(19) United States
(12) Patent Application Publication
(10) Pub. No.: US 2013/0179838 A1
(43) Pub. Date: Jul. 11, 2013

(54) MAINTANENCE OF TERMINATED APPLICATIONS WITHIN THE BACKSTACK

(71) Applicants: Brian Shawn LeVee, Seattle, WA (US); Matthew Isaac Worley, Bellevue, WA (US); Chaitanya Dev Sareen, Seattle, WA (US); Robert James Jarrett, Seattle, WA (US); Tsz Yan Wong, Seattle, WA (US)

(72) Inventors: Brian Shawn LeVee, Seattle, WA (US); Matthew Isaac Worley, Bellevue, WA (US); Chaitanya Dev Sareen, Seattle, WA (US); Robert James Jarrett, Seattle, WA (US); Tsz Yan Wong, Seattle, WA (US)

(73) Assignee: MICROSOFT CORPORATION, Redmond, WA (US)

(21) Appl. No.: 13/343,786

(22) Filed: Jan. 5, 2012

(51) Int. Cl. G06F 3/048

(52) U.S. Cl. 715/825

(57) ABSTRACT

The claimed subject matter provides for systems and/or methods for affecting the maintenance of applications, and re-launching of applications, on a backstack in a computing environment in which the applications have been killed and/or terminated. The backstack comprises a list of application that have been recently used or otherwise invoked by the computing environment or the user via the computing environment. In one embodiment, the computing environment comprises a graphical user interface (GUI) in which the user may engage in deliberate gestures to interact with applications, including the re-launching of killed or otherwise terminated applications. Upon a user command intending such relaunching, the computing environment may present to the user a temporary UI screen associated with the killed application and present a more fully functioning screen upon a commit signal to execute the killed application.

### BACKGROUND

Operating systems (OS) are typically responsible for the management of hardware resources and providing common services for application software in a computing system. Operating systems affect the loading, launching and execution of executable applications on a given computing environment and/or platform. During the course of the running of an application, the application may terminate, or otherwise be killed through a variety of mechanisms—e.g., user input, timed events, deadlock or other ways, planned or unplanned.

In today's computing platforms and/or environments, multiple applications (that in some state of execution) are tracked by the operating system—and users may interact with them via, typically, a graphical user interface (GUI). Users are able—via keystrokes and/or other deliberate actions—to see and know what and which applications are actively running. In addition, users are able—via such keystrokes and/or other deliberate actions—to switch between such applications, particularly in a virtualized, partitioned and/or multi-core computing environment.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Some embodiments of the present application provide for systems and/or methods for affecting the maintenance of applications, and re-launching of applications, on a backstack and/or, more generally, an application list (“app list”) in a computing environment in which the applications have been killed or terminated. The backstack comprises a list of application that have been recently used or otherwise invoked by the computing environment or the user via the computing environment. For the purposes of this application, the term “app list” may suffice for the term “backstack” when it is not required that the applications accessible to the user is any particular order, such as Most Recently Used (MRU).

In one embodiment, the computing environment comprises a graphical user interface (GUI) in which the user may engage in deliberate gestures to interact with applications, including the switching and/or re-launching of killed or otherwise terminated applications. Upon a user command intending such switching and/or relaunching, the computing environment may present to the user a temporary UI screen associated with the killed application and present a more fully functioning screen upon a commit signal to execute the killed application.

In one embodiment, the commit signal and/or command may be presented as a second gesture by the user. Such commit signal, as a second gesture, may give an additional control point for the computing environment—as the user's first gesture may indicate “switching” the currently running application with the killed application. As the user may ultimately decide not to “relaunch” the killed application, the second commit gesture from the user indicates to the computing environment to relaunch the killed application.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 depicts a variety of computing environments available to contemporary users.

FIG. 2 is one embodiment of a block diagram of a system and its components that may affect the maintenance of killed and/or terminated applications on a backstack for subsequent user interaction.

FIG. 3 is one embodiment of a flowchart for the handling and/or processing of killed and/or terminated application in a computing environment.

FIG. 4 is one embodiment of a timing/process flowchart for the handling and/or processing of killed and/or terminated application in a computing environment.

FIGS. 5A through 5F show a sequence of GUI screens that depict how the user might experience re-launching a killed and/or otherwise terminated application from the backstack.

FIGS. 6A through 6C show another sequence of GUI screens that depict how the user might experience re-launching a killed and/or otherwise terminated application from the backstack.

### DETAILED DESCRIPTION

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

Introduction

In the course of normal operation of a computing environment, a typical user (or users) may have several applications (alternatively called, “app” or “apps”) running and/or executing at any given time. These applications may be controlled and/or controllable via a User Interface (UI) and, more commonly, a GUI. The applications may be representable to the user as a set of icons, tiles, or the like. In addition, these applications and their representations may be controlled and/or controllable via a plurality of input/output devices or mechanisms—e.g., touch screen interfaces, mouse, keyboard, voice activation, eye tracking and/or any other means or mechanisms known in the art. The computing environment typically manages the execution and the state of such applications in the operating system of the computing environment.

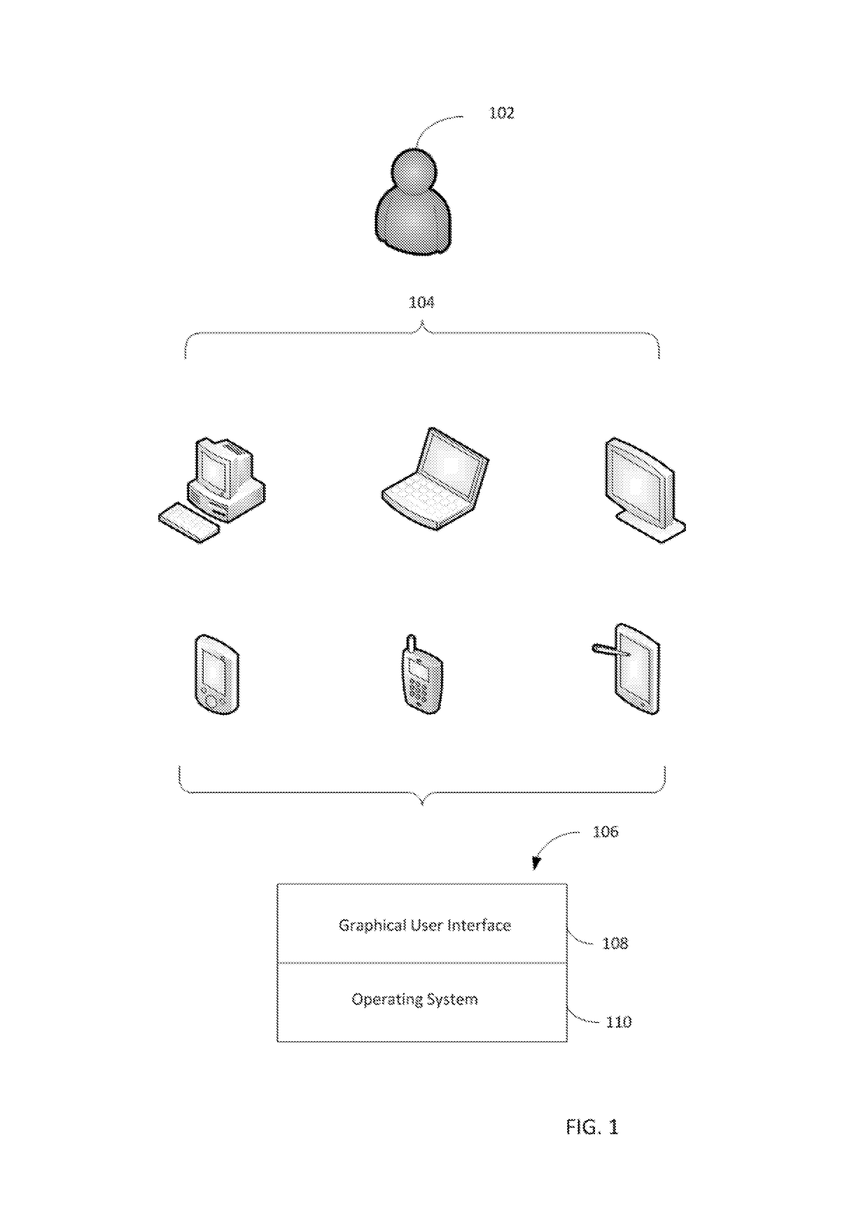

FIG. 1 shows a typical computing environment. User 102 may interact with a plurality of computing platforms—such as depicted in group 104. Such computing platforms may comprise a PC, laptop, smart device, smart phone, terminal or any other known physical device that may be in communication with various computing components. Each of these devices may be controlled directly or indirectly via a plurality of software and/or firmware layers 106. Such layers may further comprise a UI or GUI 108 and/or an operating system 110. Applications—whether directly or indirectly controlled or controllable by a user—are typically managed by the operating system.

These applications may be running in the “foreground” (that is, noticeable by the user and/or may be running in synchronously and/or in real time) or in the “background” (that is, not readily or apparently noticeable by the user and/or may be running asynchronously and/or not in real time). These applications—however they are running or in what state of execution (e.g. being launched by a user, loading, executing, suspended, being terminated, terminated or the like)—may be known and/or accessible to the user at any given time via a set of keystrokes and/or any other deliberate actions (e.g. a plurality of touches upon a touch-sensitive screen).

Such a listing and/or displaying of such applications may be stored or otherwise maintained in a data structure used by an operating system, known as the “backstack”. For merely one example of a how a user may interact with a backstack, the keystrokes—ALT-TAB or WINDOWS-TAB—in Microsoft Windows® operating system (version 7 or other earlier versions) typically produces a visual display on the screen for the user a representation of all of the active applications with which the user may like to interact—and often, in the most recently used (MRU) order.

In current operating systems, applications that had been running and/or executing—and that now may have been killed (by the user or the operating system), or otherwise terminated may not be easily accessible in the backstack or presented as an option for which the user may interact.

For purposes of the present application, the terms “killed” and “terminated” may be used interchangeably as a state of an application. Both terms refer to an application that has reached the end of its lifetime. Typically, this means the application is no longer capable of being scheduled to receive CPU time. In general, there may be at least two ways to reach this state. First, the applications may return from its last instruction (i.e. reach a halt state where there is no subsequent code to execute)—e.g., when an executable returns from its “main” function. A second way is for the OS to “kill” an application. This may typically be triggered by something external to the process itself—e.g., a user commands termination, an application crashes or ends unexpectedly, or the like.

Several embodiments of systems and methods will now be described that maintain applications that are killed and/or otherwise terminated with which the user may interact. In several embodiments, components are described for such maintenance—as well as a representations of such applications may be presented to the user via a GUI for interaction—e.g., for the re-launching of such applications.

Killed Applications

The backstack provides the user with a consistent and fast switching mechanism. Adding additional components or mechanisms for handling killed applications in the backstack should not, desirably, detract from this overall user experience.

An application may be terminated or killed while in the backstack for a variety of reasons. For example, normal termination may occur—e.g., low memory conditions on a computing platform may terminate recently used apps. Additionally, an application may crash or be hung—e.g., on-screen, in the backstack, or while switching to the application.

Also, switching between user accounts may terminate suspended apps to free up memory. When user accounts are switched, the system may suspend, then terminate, apps (or just terminate apps in the backstack) to free up memory for the new active user session. When the user switches back to the original user session, all of the apps the original user had in their back stack will typically be gone.

Other reasons for application to be killed comprise: (1) apps that want to terminate on switch because they are in a bad state; (2) apps that want to terminate on switch for extra privacy (e.g. a banking application or the like); (3) locale changes or other changes in the runtime environment that may require killing an application in order for the changes to installed.

In designing a robust system for handling and/or managing killed applications, it may be desirable that—when an application is killed while visible to the user—the killed and/or crashed application would be the next app in the backstack. In addition, the killing of an application while in the backstack should be graceful in regards to not destroying or otherwise corrupting the backstack or its contents.

### User Experience Examples

It will now be described how some embodiments of a system made according to the present application may handle killed applications in the backstack. For a first example, a user may goes to Start to launch some favorite apps: e.g., Weather, IE, and Stocks. Once the user has launched these apps—rather than go back to Start to switch between them—the user may use the backstack to quickly get back to them. Every once in a while, the user may see “temporary” UI (i.e. a quick and dirty splash screen or partial splash screen) for one of her recently used apps to indicate that it is not ready to go. However, when the user leaves it on-screen, the application quickly launches and returns to where the user was previously.

In another example, the user may experience an on-screen crash of an application. For example, suppose a user is reading up on current news in one embodiment of this application—i.e., perhaps the user is reading a newspaper's app. The user may select a new article to read, which may cause the app to crash, thus presenting the user with a wallpaper screen. The user quickly realizes that the app has crashed, and may swipe from the left edge of the touch sensitive screen (or some other deliberate gesture), which brings back the newspaper's app and launches it. Thus, in the present embodiment, the user is not required to go back to a Launcher screen to get back to crashed apps. Instead, the present embodiment may allow the user to get back to crashed apps with a single gesture.

### Manipulating and Arranging Terminated Apps

In one embodiment of the present system, killed and/or terminated applications may be manipulated and/or arranged by the user, just like running application may. In this regard, killed and/or terminated applications may respond to various user commands, such as being: (1) “switched”; (2) “snapped”; (3) “discarded” and/or (4) “pruned”. It will be appreciated that other user commands may be possible and such other or different commands are contemplated as within the scope of the present application.

For expository purposes, a user may “switch” applications—which is to say, that one application, which is running in the foreground and presented to the user via the UI, may be substituted in the foreground and presented to the user via the UI by another application. A user may “snap” an application, such that the “snapped” application now shares the foreground and presentation to the user with another application. A user may “discard” an application, such that the “discarded” application may no longer be presented to the user via the UI, but the discarded application may still be executing (unless terminated) and maintained in the backstack. A user may “prune” an application, such that the “pruned” application is terminated. If the pruned application is running, then pruning would cause the application to terminate and be removed from the backstack. If the pruned application is already killed, then pruning would cause the application to be removed from the backstack.

Each of these user commands may be delivered to the computing environment in any manner known—e.g., including via gestures made upon a touch sensitive display screen. For example, switching and/or snapping commands may be accomplished with a swiping gesture—e.g., from the left or right side of the screen. Discarding commands may be accomplished by touching a portion of the UI representing the application and “tossing” the application back into the backstack. Pruning commands may be accomplished by touching a portion of the UI presenting the application and “tossing” the application to a location, such as the bottom of the screen. Other gestures are of course possible and it suffices that suitable gestures be known by the user and consistent for the sake of a proper user experience.

In other embodiments, systems made in accordance with the present application may have the following attributes with respect to applications that are killed: (1) if an app is terminated while in the backstack, the app will remain in the backstack (and, in one embodiment, in the same position in the backstack as when the app was running); (2) killed apps may be represented with a splash screen comprising temporary visuals; (3) the killed app may be switched to, snapped, discarded and/or pruned (or any other possible user command given to an application e.g., via the UI) like any other app (whether executing or any other suitable state); (4) the killed app may be activated upon a given event—e.g., when a switching timeout occurs. In each instance, it may be the case that the computing environment presents a temporary representation of the killed app such that the temporary representation may be manipulated and arranged like a running application. In such instances, temporary representations may be positioned as, e.g., an app window on a desktop (or elsewhere) before the killed app is re-launched.

In yet other embodiments, systems made in accordance with the present application may have the following attributes with respect to applications that either crash or hang: (1) if an on-screen app crashes, the user may be taken to a desired background and the crashed app will be the next thing in the backstack—represented with its splash screen; (2) if an app crashes or hangs while switching back to it via the backstack, the user may be taken to a desired background and the hung/crashed app will be the next thing in the backstack.

In yet other embodiments, systems made in accordance with the present application may have the following attributes with respect to the on-screen representation of the application: (1) when the user switches to an app that has been killed or terminated while in the backstack, the app will be represented using temporary visuals, which are created when the app is brought on-screen; (2) if the killed app is activated on-screen, the splash screen temporary visual may be handed off so that the transition occurs smoothly; (3) if the user switches away from the killed app, the splash screen temporary visual may be destroyed.

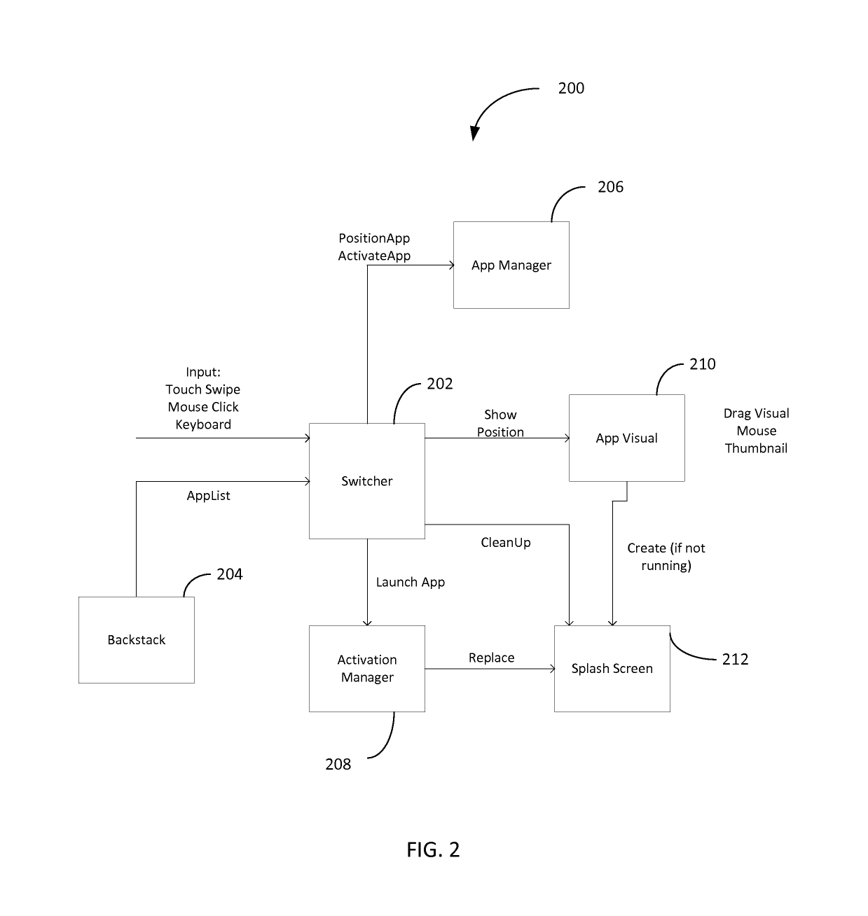

Having described some embodiments and a few of their aspects and attributes, some other embodiments will now be disclosed. FIG. 2 depicts a portion of a system (200) comprising components capable of maintaining applications that are killed and/or otherwise terminated for presentation to the user and subsequent re-launching and execution. System 200 comprises switcher component 202 which accepts as input a plurality of user commands—e.g., a touch swipe, a mouse click, keyboard strokes or the like. User commands may be made to view a listing of applications that are in a plurality of states—e.g., executing, killed, terminated or the like. This list may comprise any suitable data structure (AppList) presented by backstack component 204.

Switcher component 202 manages the lifetime of a switch session. When the session starts, switcher 202 may create a snapshot of the current backstack. Additional switches may move the user further through this stack and prolong the session. The session ends when the user interacts with an app or after a short timeout between switches. Switcher component 202 communicates with App Manager 206 and Activation Manager 208 which aid in the management of activating and launching applications.

In order to support switching to non-running applications, switcher may pre-create the splash screen for an application that is not currently running. This window may be created by App Visual 210 and Splash Screen 212—in particular, if there is no window and/or UI screen currently running for a killed application. When the user commits to switching to a non-running app, switcher may hand off this window to the window activation context. When the app is re-launched, the activation code may reuse the existing window, instead of creating a new splash screen. At the end of the switch mode, if the user did not launch the app associated with the temporary visual, switcher will destroy the window.

While switching, the system may create a couple of controls to affect switching: the App Visual and the Drop Feedback. In one embodiment, only one instance of the Drop Feedback control may be used by the switcher at a time. In addition, there may not be more than two instances of the App Visual created by the switcher, and there is usually only one at a time.

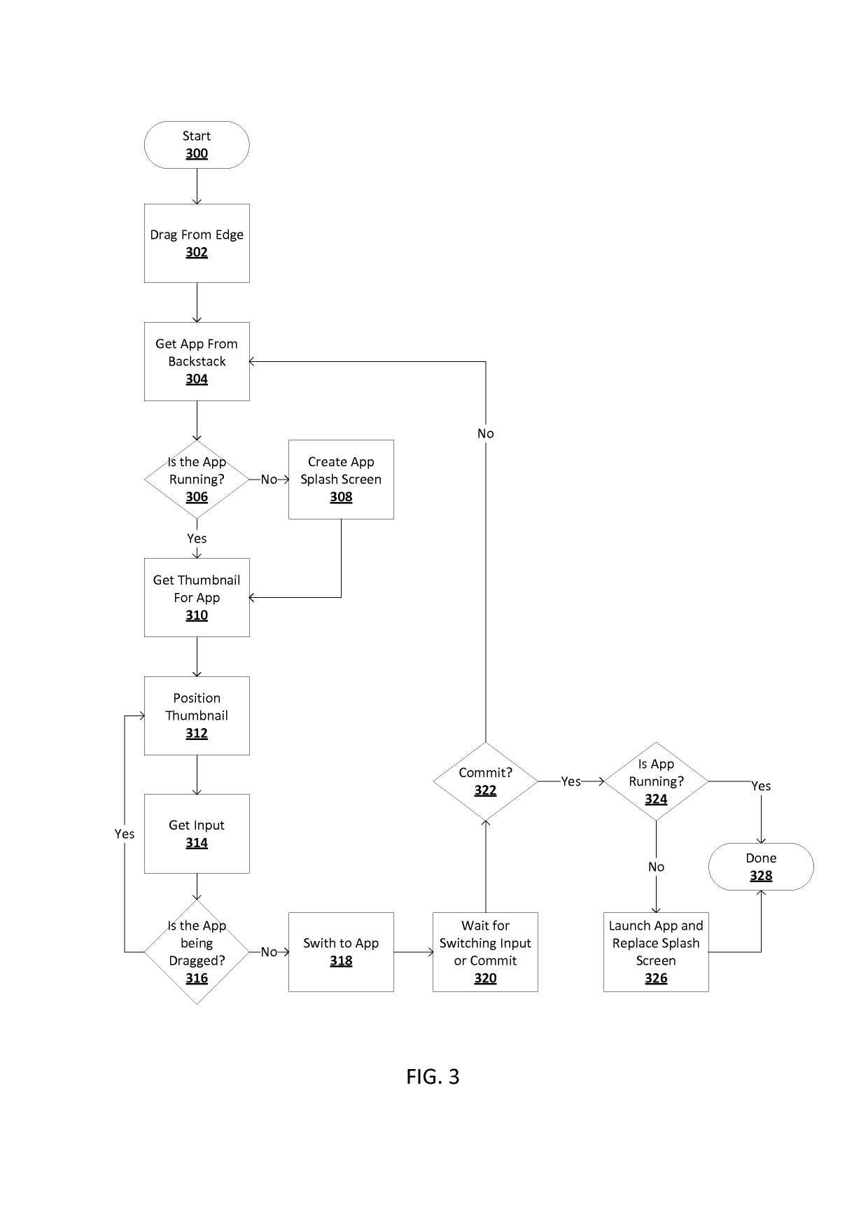

FIG. 3 depicts one high level flowchart for one embodiment of a system having a GUI and operating system as described above. The system, starting at 300, may allow an actuation of an application by a deliberate user action—e.g. drag from the edge of a touch sensitive screen at 302. The system, at 304, would attempt to get the application from the backstack and detect if the application is currently running at 306. If not, then the system may create a splash screen for the application 308—and, in either event (that is, whether the application was running or not), the system may get a thumbnail for the application at 310.

The system may position the thumbnail at 312—with or without user's input. In addition, the system may get input at 314—e.g., as to where the application's UI screen may be residing on the screen. At step 316, the system may inquire or otherwise monitor whether the application is being dragged—and if so, the system may repeat at step 312.

Once the application is no longer being dragged, then the system may switch the foreground UI and/or processing to the application at 318. The system at step 320 may wait for switching input or commit. In one embodiment, a “commit” command and/or signal refers to the determination of whether the user has finished switching. For example, this may be the point at which the system has high confidence that the user means to interact with the current app. If the current app is represented by a splash screen, this is when the app will be relaunched.

Other embodiments could choose different triggers for commit. For example, commit might apply: (1) as soon as the splash screen is placed on screen; (2) at an arbitrary timeout; (3) at the time of interaction with a temporary visual or (4) upon any user input associated with committing. It should be appreciated that other implementation may use a combination of triggers, or other such suitable triggers. It would suffice that—for whatever trigger or command is associated with “commit”, the computing environment should delay the launch until user intent is clear. As launching may be expensive in CPU and disk usage, it may be desirable to avoid unnecessary launches. If there is no commit at 322, then the system will continue to step 304. However, if there is a commit at step 322, then the system may check at 324 as to whether the application is running. If so, then the system is done at 328. Otherwise, the system will launch the application and replace the temporary UI with its usual functioning splash screen at 326.

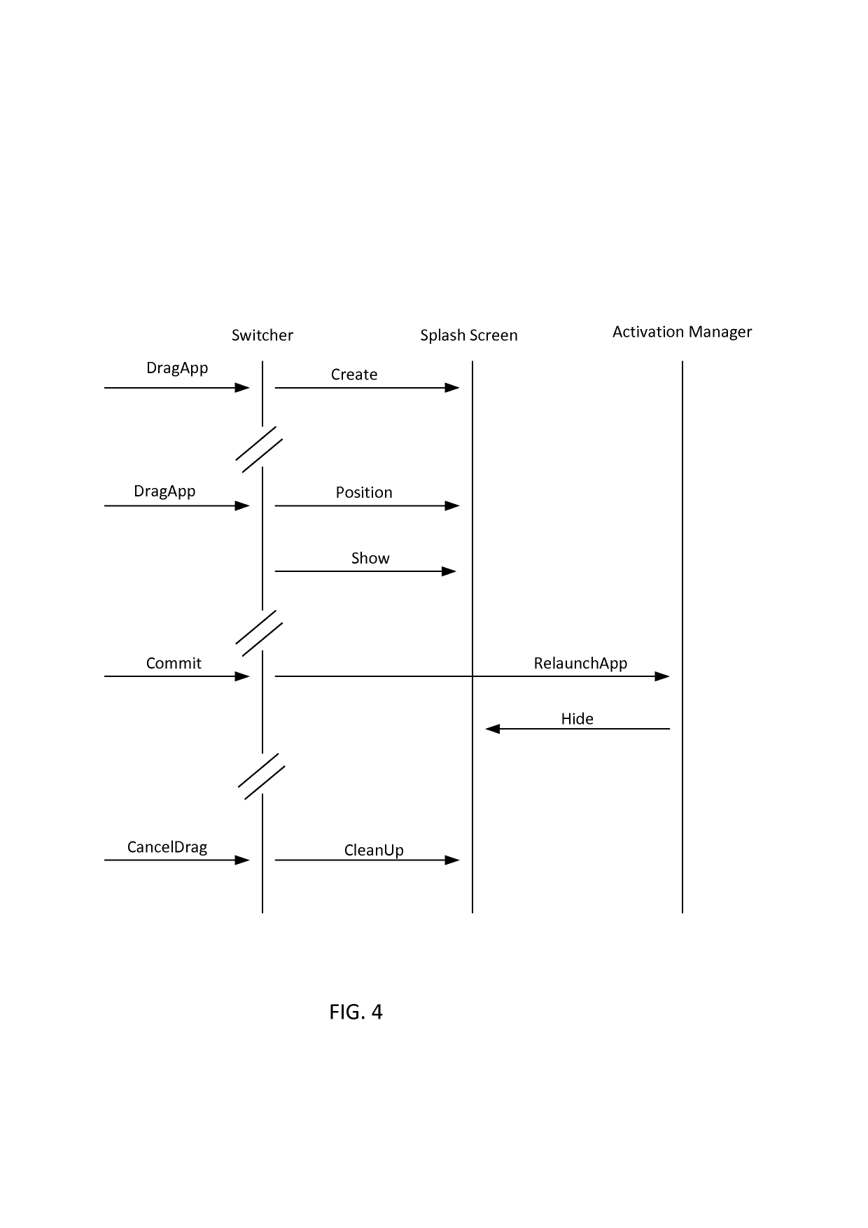

FIG. 4 depicts one high level timing diagram that depicts a flow of processing between the switcher component, the splash screen component and the activation manager component. As shown, upon detecting an application dragging, switcher component may send a signal to splash screen component to create a temporary UI, if needed (particularly if the application is not currently executing). In addition, switcher component may send a signal for position and showing of the UI screen to the splash screen component.

If the switcher component detects a commit signal, then the switcher component may send a relaunch application signal to the activation manager component and, in return, the activation manager component may send a swap signal to the splash screen component. A swap signal may affect the replacement of the temporary visual is replaced with the actual application. Once the application is able to represent itself, the temporary visual is not needed and it may be destroyed to free up resources.

Alternatively, if the switcher component detects a CancelDrag signal, the switcher component may then send a CleanUp signal to the splash screen component. In this case, if the user chose not to switch to the temporary visual, then the temporary visual is no longer needed and its resources may be freed up.

### User Interface Examples

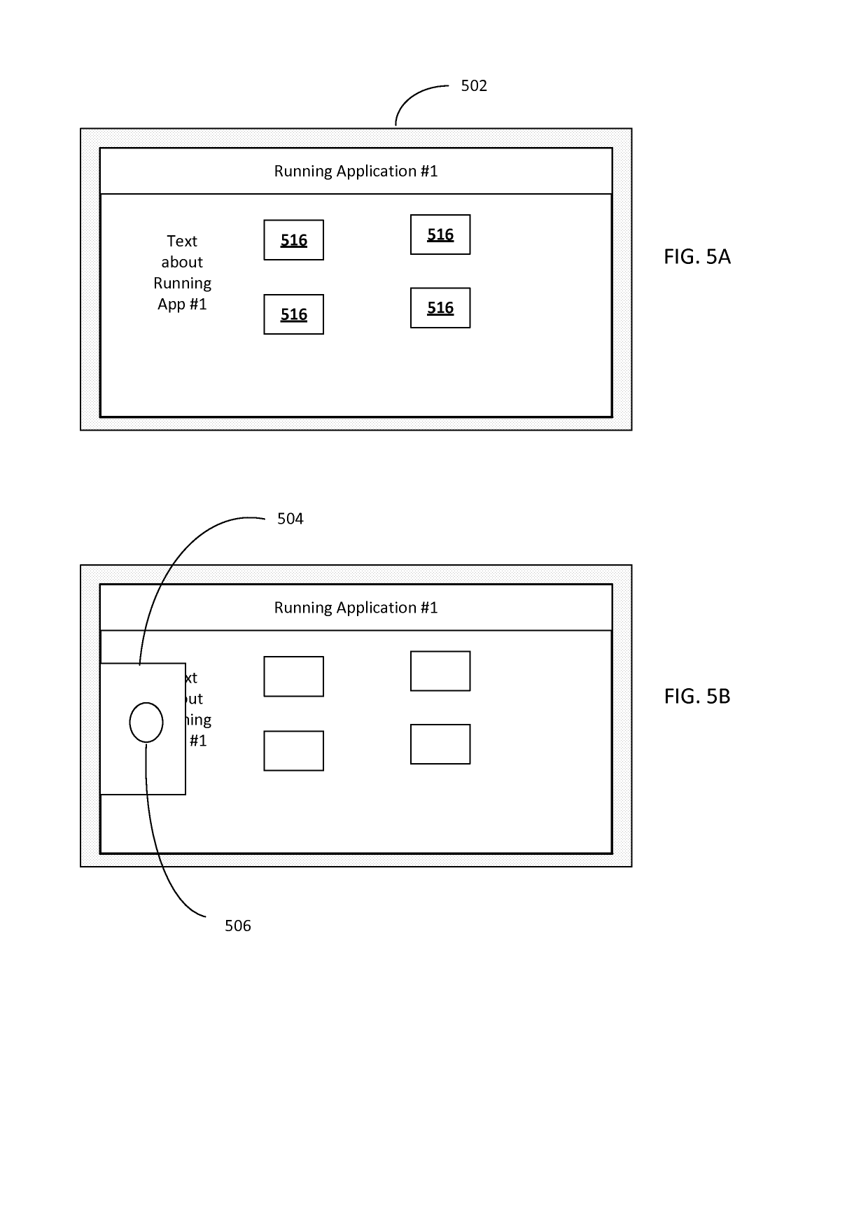

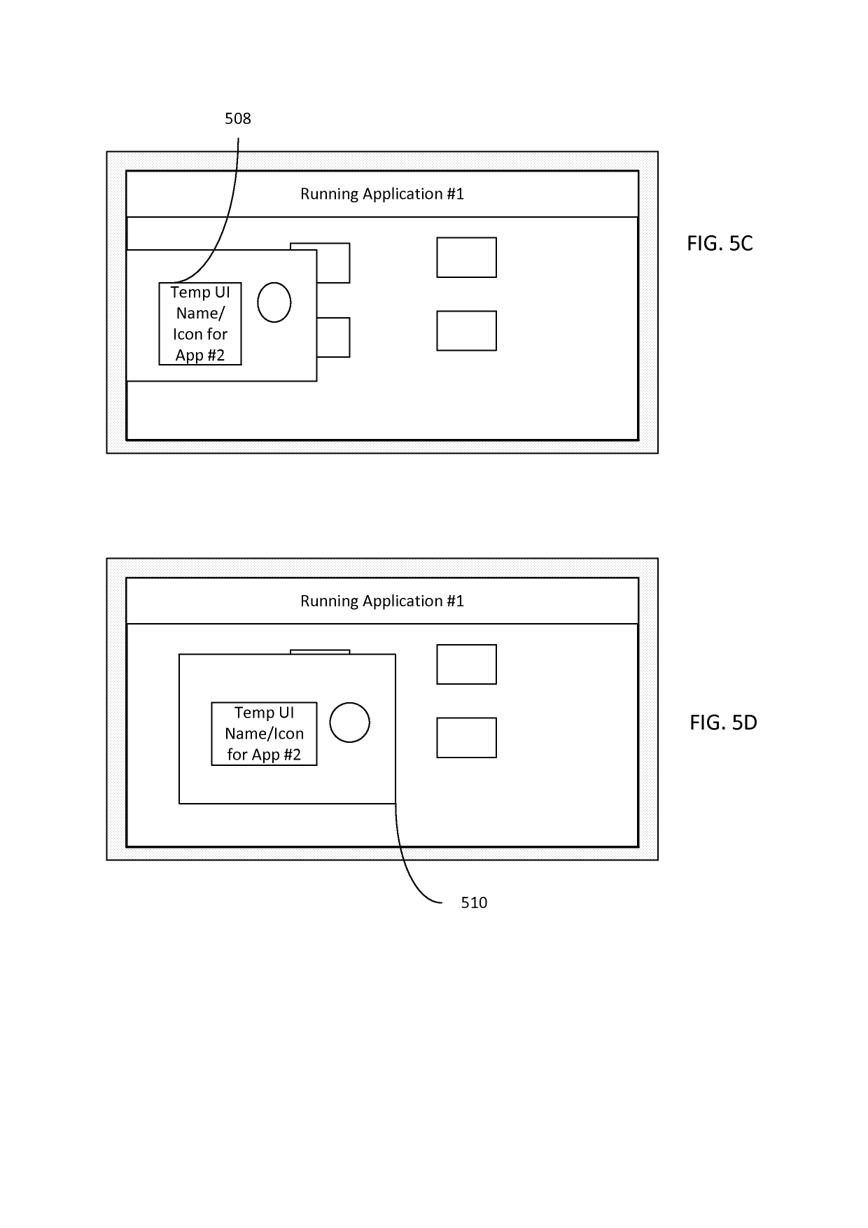

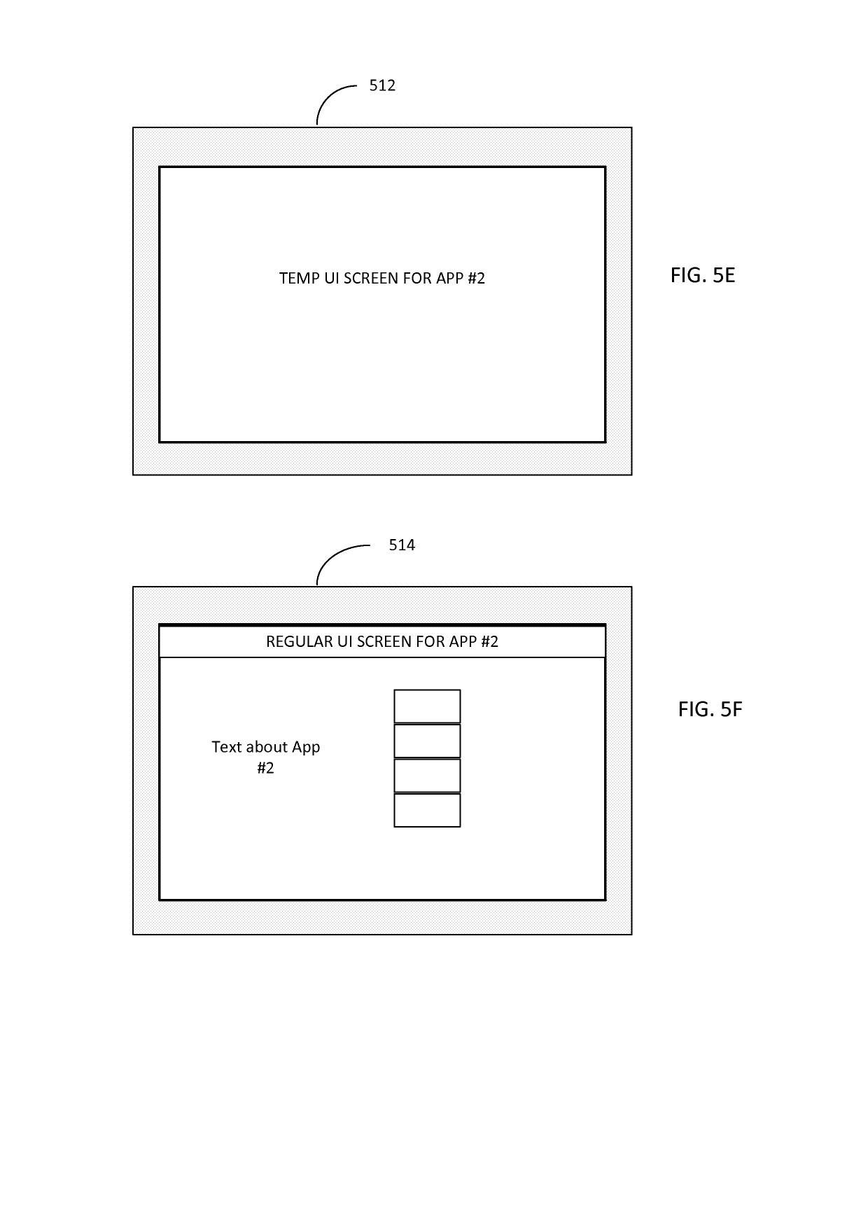

FIGS. 5A through 5F show a sequence of GUI screens that depict how the user might experience re-launching a killed and/or otherwise terminated application from the backstack. Suppose a user is in a running application in some computing environment and running a first application 502 (say, Shutter Web and its associated UI depicted in FIG. 5A). Further assuming that the computing environment comprises an active touch sensitive screen and GUI (e.g., with touch sensitive commands 516 for Running Application #1, as shown), the user may attempt to access a killed application from the backstack by a deliberate gesture—such as depicted in FIG. 5B as a swiping motion or gesture from the left edge of the touch sensitive screen.

A temporary UI screen (representing the killed application) becomes visible at 504—with the user's digit hold at point 506. The user—via the digit hold—may move the temporary UI screen to a new location on the screen (e.g., moving to the right, as depicted in FIG. 5B). Such a touching gesture, made upon (or otherwise associated with) the UI screen may also signal a commit signal—from the user to the computing environment—that the user desires the application to start execution. In some embodiments, the end position of the touching gesture may impart a signal to the computing environment to either start execution (e.g. if the user's digit hold slows and/or stops upon some intermediate point in the touch sensitive display screen)—or not to start execution (e.g. if the user's digit does not slow down sufficiently and/or the user continues the swiping gesture to impart a virtual “velocity” to the UI screen to carry it off the surface of the touch sensitive display screen).

In other embodiments, the manner of “dropping the visual” may be associated with user intent. For example, different areas of the screen where a visual is dropped may be associated different behaviors. In some embodiments, dropping the visual near the edge may indicate the app should not be brought on screen. Dropping elsewhere may indicate the app should be brought on screen. The approximate location of the drop may determine what part of the screen the app should occupy.

In one embodiment, the temporary UI screen may include some indicia of what the killed application is—e.g. a temporary (and perhaps, perfunctory) icon 508 like “Weather” (or any other suitable App #2). The temporary UI screen and/or icon may be a screen that has less graphical information and/or functionality that the UI screen that is regularly associated with the application when it is executing or otherwise functioning. The operating system may process the presentation of the killed application differently (as it appears to the user) by the distance and/or location that the user drags the temporary UI screen. As seen in FIG. 5D, the user has dragged the temporary UI screen to a certain position (e.g. past the middle portion 510 of the entire screen)—which may indicated to both the operating system that user intends that the soon-to-be-relaunched killed application is to consume the entire screen.

FIG. 5E depicts, in this example, that the re-launching killed application is to occupy the entire screen—as the temporary UI screen 512 has consumed the entire screen area. In FIG. 5F, the operating system has now successfully launched the Weather application (or any other suitable App #2) and is now executing, as depicted with its normal UI screen 514 fully functioning.

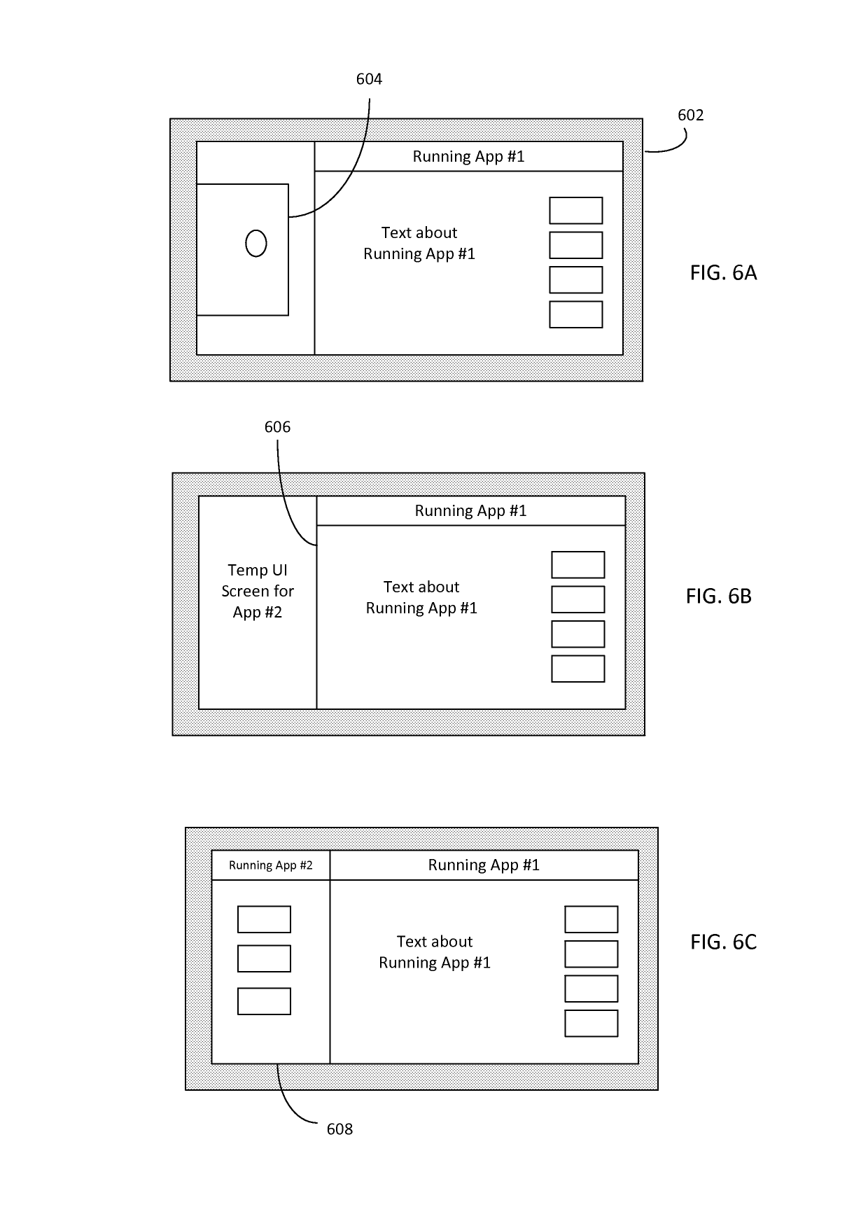

FIGS. 6A through 6C show another sequence of GUI screens that depict how the user might experience re-launching a killed and/or otherwise terminated application from the backstack. FIG. 6A shows again a user's screen with one application 602 currently executing in one portion of the screen. In the left hand portion of the screen, there is an area for another application to be executing and presenting a UI screen to the user. Killed application 604 (and its associated temporary UI) is being dragged to a location 606 in FIG. 6B within that left hand portion, with the user's digit hold depicted as the circular element. FIG. 6C depicts that the system has re-launched the killed application and is currently executing within its portion of the screen and its full UI screen functioning at 608.

It should be appreciated that other embodiments may allow more than two apps may appear on screen at any given time. Such other embodiments may choose other rules for laying out apps on screen. For example, these embodiments may or may not involve overlapped windows or limits on the number of displayed apps or the size of those apps. It suffices for the purposes of the present application that the positioning rules affect some fashion of positioning an app before it is launched.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A method for maintaining killed applications in an app list in a computing environment, said computing environment comprising a one or more processors, computer readable memory, input and output components, a user interface (UI), said UI providing a representation of applications available to a user, and an operating system for managing the loading, launching, execution of applications, the steps of said method comprising:
updating a list of a set of applications in an app list, said applications available to a user in said computing environment;
when one of said applications transitions from the executing state to a killed state, maintaining the killed application in the app list;
upon a signal from the user indicating a command to select said killed application from the app list, creating a temporary UI screen associated with said killed application;
presenting the temporary UI screen upon at least a portion of the UI, said temporary UI screen capable of being dragged by the user upon said UI; and
replacing the temporary UI screen with the regular UI screen associated with said application once executing upon a commit signal from said computing environment.

2. The method of claim 1 wherein said app list comprises a list of a group of most recently used applications, said group comprising: currently running applications and killed applications.

3. The method of claim 1 wherein said signal from the user comprises one of a group, said group comprising: gesture upon a touch sensitive screen, mouse gesture, keyboard gesture, voice activation signal, eye tracking signal.

4. The method of claim 1 wherein said temporary UI screen associated with said killed application comprises a screen comprising less graphical content than a UI screen associated with said application when executing.

5. The method of claim 1 wherein said temporary UI screen associated with said killed application comprises a screen comprising less functionality than a UI screen associated with said application when executing.

6. The method of claim 1 wherein said temporary UI screen comprises a touch activated UI screen rendered upon a touch sensitive display screen and said touch activated UI screen is capable of being dragged by said user upon a touching gesture made upon said touch sensitive display screen.

7. The method of claim 6 wherein said commit signal comprises the cessation of touching gesture by said user according to certain end conditions of said touching gesture.

8. The method of claim 6 wherein the step of replacing the temporary UI screen with the regular UI screen associated further comprises:
expanding the regular UI screen to the full dimensional limits of the touch sensitive display screen.

9. The method of claim 6 wherein the step of replacing the temporary UI screen with the regular UI screen associated further comprises:
expanding the regular UI screen to a lesser portion of the full dimensional limits of the touch sensitive display screen.

10. The method of claim 9 wherein regular UI screen shares the full dimensional limits of the touch sensitive display screen with another UI screen of another executing application.

11. A computing environment for a user, said computing environment further comprising:
a processor;
computer-readable memory, said computer-readable memory capable of storing applications, said applications being executable by said processor;
input and output components;
a plurality of applications, said applications being responsive to input commands from said user;
a graphical user interface (GUI) for presenting visual information to said user;
an operating system for the management of the execution and other potential states of said application; and
wherein said operating system further comprises:
a switcher component, said switcher component capable of accepting inputting signals from said user to switch to applications that were recently used and currently in a killed state;
a backstack component, said backstack component comprising a list of applications recently used by said computing environment; and
a splash screen component, said splash screen component capable of creating a temporary UI screen renderable upon said GUI for a killed application that said user has given a deliberate gesture indicating a command to re-launch said killed application in said backstack component and further wherein said temporary UI screen capable of being moved by said user upon said GUI prior to re-launching.

12. The computing environment of claim 11 wherein said computing environment further comprises a touch sensitive display screen and said user may give a swiping gesture upon said touch sensitive display screen indicating a command to relaunch said killed application.

13. The computing environment of claim 12 wherein said swiping gesture further comprises a touching gesture such that ending conditions of said touching gesture indicates a commit signal to said computing environment to re-launch said killed application.

14. The computing environment of claim 13 wherein said temporary UI screen comprise a screen comprising less graphical content than a UI screen associated with said application when executing.

15. The computing environment of claim 13 wherein said temporary UI screen associated with said killed application comprises a screen comprising less functionality than a UI screen associated with said application when executing.

16. One or more computer-readable storage media comprising executable instructions to perform a method, the method comprising:
updating a list of a set of applications in a backstack, said applications available to a user in a computing environment;
when one of said applications transitions from the executing state to a killed state, maintaining the killed application on the backstack;
upon a signal from the user indicating a command to re-launch said killed application, creating a temporary UI screen associated with said killed application;
presenting the temporary UI screen upon at least a portion of the UI, said temporary UI screen capable of being moved by said user upon said GUI prior to re-launching said killed application; and
replacing the temporary UI screen with the regular UI screen associated with said application once executing upon a commit signal from said computing environment.

17. The one or more computer-readable storage media of claim 16 wherein said signal from the user comprises one of a group, said group comprising: gesture upon a touch sensitive screen, mouse gesture, keyboard gesture, voice activation signal, eye tracking signal.

18. The one or more computer-readable storage media of claim 16 wherein said temporary UI screen associated with said killed application comprises a screen comprising less graphical content than a UI screen associated with said application when executing.

19. The one or more computer-readable storage media of claim 16 wherein said temporary UI screen comprises a touch activated UI screen rendered upon a touch sensitive display screen and said touch activated UI screen is capable of being dragged by said user upon a touching gesture made upon said touch sensitive display screen.

20. The one or more computer-readable storage media of claim 19 wherein said commit signal comprises the cessation of touching gesture by said user according to certain end conditions of said touching gesture.
